(19) United States
(12) Patent Application Publication
(10) Pub. No.: US 2015/0083549 A1
(43) Pub. Date: Mar. 26, 2015

(54) SYSTEM AND METHOD FOR SORTING ARTICLES

(71) Applicant: Mukesh Ram, Cincinnati, OH (US)

(72) Inventor: Mukesh Ram, Cincinnati, OH (US)

(21) Appl. No.: 14/128,222

(22) PCT Filed: Jun. 27, 2012
(86) PCT No.: PCT/US2012/044302

§ 371 Date: Nov. 10, 2014

Related U.S. Application Data
(60) Provisional application No. 61/501,538, filed on Jun. 27, 2011.

(51) Int. Cl. B65G 47/46; B65G 17/12; B65G 47/38; B65G 43/00

(52) U.S. Cl. CPC B65G 47/46; B65G 43/00; B65G 17/12; B65G 47/38
USPC 198/358

(57) ABSTRACT

Described herein is a method for configuring a sorting system with multiple carriers. A sensor is provided on one of the sensors and the sensor is passed across a number of divert locations. An index feature at each divert location is detected by the sensor and the logical position of each divert location is determined. The divert locations are then indexed to the logical position.

### CROSS-REFERENCE TO RELATED APPLICATION

This application claims the benefit of U.S. Provisional Application Ser. No. 61/501,538, filed Jun. 27, 2011, the contents of which are fully incorporated by reference herein.

### BACKGROUND

The present disclosure is directed to a system and method for operating a sorting system, and more particularly to a system and method for configuring a sorting system

Sorting systems of the loop conveyor type are well known. Sorting systems, including loop conveyor sorting systems, have been adapted to sort articles such as mail, packages, luggage, and other discrete objects. Sorting systems of this type have been deployed in post offices, warehouses, retail distribution centers, airport terminals, and other locations where sorting operations are required.

What has been needed is a system and method of calibrating a sorting system that improves upon those available in the past.

### SUMMARY

A method for calibrating a sorting system is disclosed having a number of carriers comprises providing a sensor on one of the carriers and passing the sensor across a number of divert locations. An index feature at each divert location is detected by the sensor and the logical position of each divert location is determined. The divert locations are then indexed to the logical position.

An apparatus for configuring a sorting system is also disclosed. The apparatus comprises a carrier tray having a sensor, wireless transmitter, and power supply mounted thereon. The sensor is configured to detect a divert location of the sorter system and the wireless transmitter is in communication with the sensor. The power supply is coupled to the sensor and wireless transmitter.

Also disclosed is a system for configuring a sorting system. The system comprises a conveyor for transporting articles from a load station to a number of offload stations, a number of divert locations for transferring the article from the conveyor to the offload station, a control system for activating the diverter at a predetermined time and a configuration tray removably attachable to the conveyor. The configuration tray includes a sensor for detecting the physical position of the diverter and a transmitter for communicating the position of each diverter to the control system.

### BRIEF DESCRIPTION OF DRAWINGS

FIG. 1 is a top elevational view of a sorting system;

FIG. 2 is a side elevational view of an individual divert location;

FIG. 3 is a perspective view of a configuration tray; and

FIG. 4 is a flowchart illustrating the configuration and sorting operations.

### DETAILED DESCRIPTION

Presently disclosed is a system and method of operating a sorting system and a system and method for calibrating or configuring a sorting system.

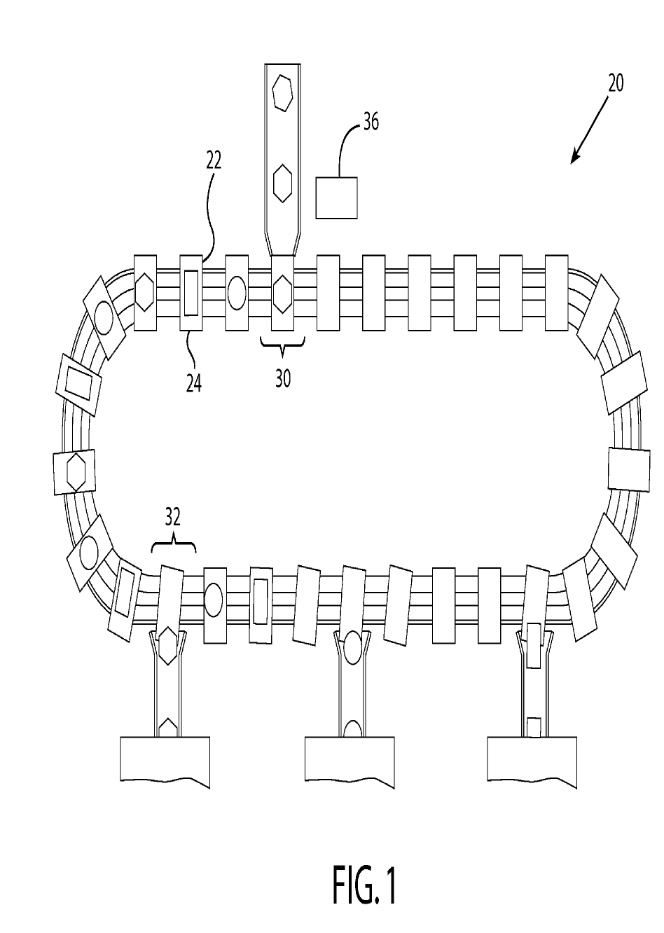

As illustrated in FIG. 1, a sorting system 20 comprises loop conveyor 22 with a number of carriers 24 allowing continuous operation and increased throughput of the system. Each carrier 24 is configured to transport an article to be sorted from at least one load station 30 to a preselected divert location 32. In the embodiment illustrated, the loop conveyor 22 includes thirty (30) discrete carriers 24 and one load station 30. However, it is contemplated that more or fewer discrete carriers 24 may be provided and additional load stations 30 may be provided.

Further according to FIG. 1, the loop conveyor 22 includes discrete carriers 24 each configured to transport a single article. The carriers 24 are shown to be tilt-type carriers that discharge the article to be sorted by tilting the tray at the divert location 32. Alternatively, the carriers 24 may be tilt trays, tilt-shells, bomb-bay, hook conveyors, or other designs known in the art. The sorting system 20 is shown having discrete carriers 24, however the term “carrier” should be understood to include discrete bins, each containing an article to be sorted; a continuous path, such as a conveyor belt, where each article to be sorted is not separately binned; and a sorter where each bin contains multiple items to be sorted.

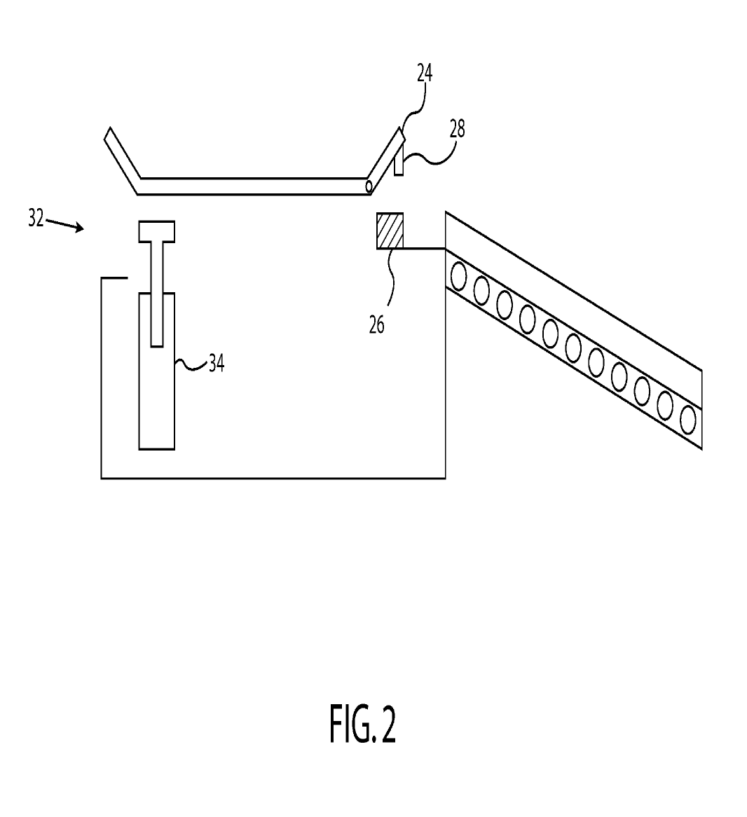

Each divert location 32 includes a divert device 34 (FIG. 2) for directing the article to be sorted from the carrier 24 to an output path, such as an inclined roller, bin, or other output. In FIG. 2, the divert device 34 is a lifting arm or other structure for engaging the tilt-tray type carrier 24 as the carrier 24 passes the divert location 32. According to various alternative embodiments, the divert device 34 is a pusher, ram, movable wheel, or other device known in the art corresponding to the type of carrier 24 selected.

A central controller 36, shown in FIG. 1, such as a programmable logic controller, computer-based software, hardware system, microcontroller, or other apparatus for receiving and transmitting electrical commands to the divert devices 34, is also provided that includes an index of the logical position of each divert locations 32 and the preferred divert location 32 for an article to be supported. The controller 36 is in communication with divert devices 34 at each divert location 32 and is configured to transmit a signal to one or more divert devices 34 to engage the carrier 24 and direct the article to be sorted to an output path.

In order for the article to be sorted to be delivered accurately to a specific output at the divert location 32, it is important to first calibrate the sorting system 20 by determining the logical position of the divert location 32 relative to a reference point, such as the load station 30 so that the divert device 34 is activated at the proper time. This calibration is performed in a calibration operation where the actual, physical location of the divert locations 32 is converted into a logical position of the divert location 32. The logical position of the divert location 32 may be determined based on physical distance, time delay, angular displacement, electrical signal, or carrier index.

Once the logical position of the divert location 32 is determined the sorting system 20 may operate in a sorting mode. During the sorting mode, articles to be sorted are provided at a load station 30 and loaded into the carrier 24 and delivered to the divert location 32 where they are offloaded.

FIG. 2 illustrates an individual divert location 32 in further detail. Located at each divert location 32 is divert device 34 that engages individual carriers 24 to remove the article to be sorted from carrier 24. Divert device 34 may be, according to various alternative embodiments, a tilt-tray, bomb-bay drop, sliding shoe, or other type of device, including pneumatic devices, for removing articles from carriers 24 to an output path. Each divert device 34 is individually accessible and selectively engagable by the controller 36 to release articles to be sorted from the carrier 24.

Each divert location 32 includes an index feature 26 configured to be detected by a sensor 28 mounted to one or more carriers 24. The index feature 26 may be a structural component of the divert device 34 or separate component. The sensor 28 located on the one or more carriers 24 may be a proximity sensor, optical sensor, electrical sensor, image detector, physical switch, or other type of apparatus capable of detecting and electrically communicating the presence of the index feature 26. In one instance, the sensor 28 is an optical sensor that transmits and captures a beam of light reflected from the index feature 28. In another instance, the sensor 28 is an electrical sensor that detects a certain frequency of electrical energy, such as from an RFID chip, and the index feature 26 is an RFID chip. In yet another instance, the sensor 28 is a physical switch, such as a lever or pushbutton, that is triggered by physical contact with the index feature 26. In another instance, the sensor includes image or video capture software that searches for specific reference points, such as colored tags, that make up the index feature 26.

Various methods of determining the logical position of each divert location 32 are contemplated. In a first method, the logical position of each divert location 32 is based on the index position of discrete carriers 24. According to this method, each discrete carrier 24 is provided with a sequential index number in the direction of travel, from #0 to #29 in the embodiment illustrated in FIG. 1. The sensor 28 is provided at the first carrier 24, index #0. As the carrier 24 travels from a reference point, such as load station 30, the sensor 28 will detect the index feature 26 of each divert location 32. The load station 30 is used as the reference point for illustrative purposes, however it is contemplated that other reference points may be used.

As the sensor 28 detects the index feature 26 of each divert location 32, a signal, such as an electrical signal, is transmitted to the controller 36. When the controller receives the electrical signal the index number of the carrier 24 located at the reference point is recorded. By way of example, the first divert location 32 may be detected when the carrier 24 indexed at #10 is located at the load station 30. This allows a configuration lookup table to be developed, indexing each divert location to a carrier index. A sample of this configuration lookup table is demonstrated in the following Table 1:

TABLE 1

| Load Station Index | Divert Location |
|---|---|
| #10 | #1 |
| #15 | #2 |
| #18 | #3 |
| #25 | #4 |

This table allows for the locating of divert locations 32 based on the index of the carrier 24 located at the reference or load station 30. By way of example, when an item is loaded into the carrier 24 indexed at #0 that carrier will be at divert location #1 when the carrier 24 indexed at #10 is in the load station 30. Additionally, the carrier 24 indexed at #0 will be at divert location #4 when the carrier indexed at #25 is at the load station 30. An algorithm may be developed to determine the load station index for each carrier and divert location. This determination may be by means of a lookup table or by calculation.

Various other methods are also contemplated. According to one variation, rather than assigning a single index to a single discrete carrier 24 multiple index numbers may be assigned to a single carrier, or a single index number may be assigned to multiple carriers. According to another method, index numbers are not based on the carriers 24 but other reference sources. For example, a continuous drive train, such as a chain or conveyor, may be provided that connects and transports the carriers between the load station(s) and divert location(s). This continuous drive train may be indexed by links or sections.

Also contemplated are non-indexed methods of determining the logical position of the divert locations 32. In one method, the logical position of each divert location 32 is provided based on the elapsed time between signals. This time delay may be converted into a distance measure or may be maintained as a time measurement. Finally, while it is preferred that the indexed locations of the divert locations 32 are communicated wirelessly to the controller 36, it is also contemplated that the sensor 28 may communicate through a direct connection or may store the information and require an additional step, such as a plug-in connection or manual input, to communicate the logical position of each divert location 32 to the controller 36.

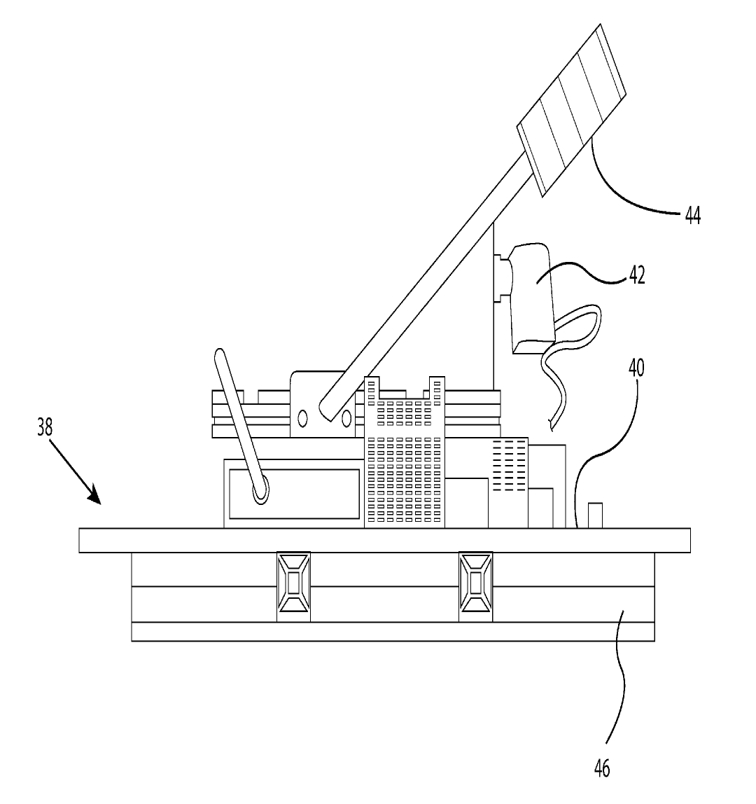

FIG. 3 illustrates a configuration sorter tray 38 that is used to configure a sorter system 20 in a configuration operation according to the first embodiment. In this embodiment, the configuration sorter tray 38 includes a tray 40, power supply 42, wireless input/output 44, and one or more laser photoeyes 46 with a beacon 48 for visible system feedback. The beacon 48 may be a lamp, laser, flag, or other signaling device providing user feedback. In the illustrated embodiment, the beacon 48 includes three lamps for indicating to a user (1) normal operation; (2) detection of a divert location 32; and (3) errors. In the illustrated configuration sorter tray 38, the laser photoeye 46 projects a laser that is reflected from the index feature 26 back to the photoeye 46.

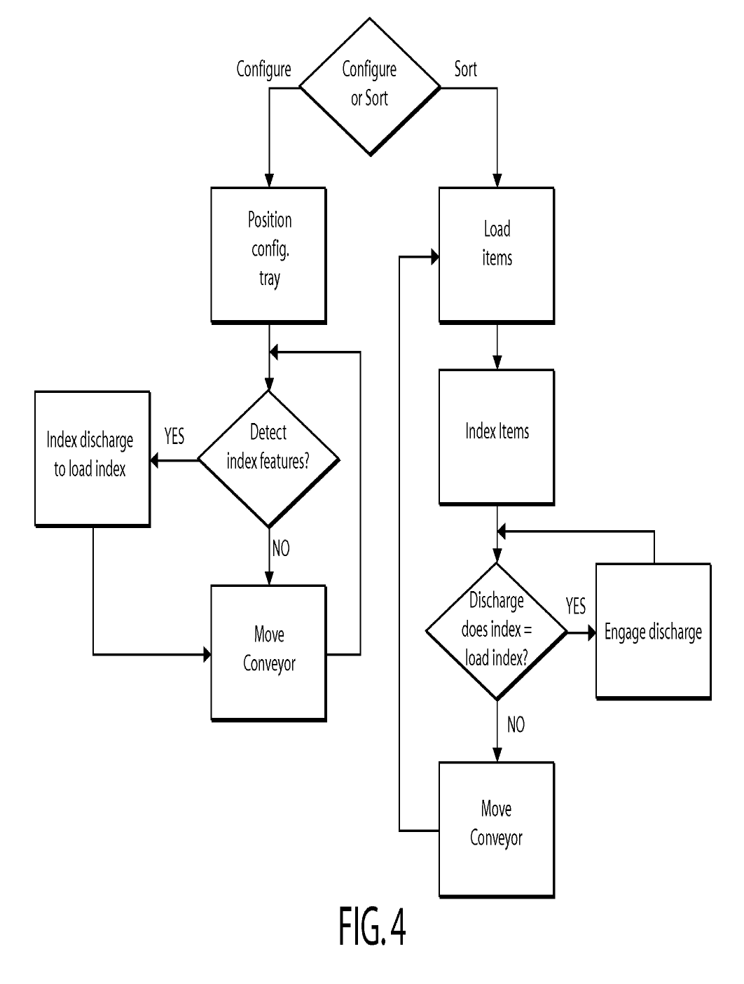

FIG. 4 is a flowchart illustrating a method for sorting articles in a sorting system 20 from a load station 30 to an output path.

As shown in FIG. 4, the sorting system 20 includes a configuration operation and a sorting operation. The configuration operation is provided to determine the logical positions of various divert locations 32 relative to a reference point, such as the load station 30. This operation may be run during the set-up of the sorting system 20, when divert locations 32 have been added, removed, or moved in the system 20, or whenever re-calibration is necessary. The sorting operation is provided for normal operation of receiving, detecting, and delivering articles to be sorted from a load station 30 to a preferred divert location 32.

During the configuration operation, the configuration sorter tray 38 is placed on the loop conveyor 22 of the sorting system 20 replacing one of the carriers 24. As the configuration sorter tray 38 passes each divert location 32, the sensor 28, such as laser photoeye 46, detects the presence of the divert device 34 or other index feature 26. The presence of the index feature 26 is communicated via the wireless I/O to the central controller 36. This communication may be by a variety of methods, including wireless Ethernet, radio transmission, or other wireless method. The central controller 36 receives the wireless signal and records the logical position of the divert device 34 according to the methods described above. After the loop conveyor 22 completes one cycle, the logical positions of the divert locations 32 will have been determined Additional cycles may be used to confirm or verify the logical positions of the divert locations 32.

In the preferred method, the configuration sorter tray 38 is provided with index #0 at the load station 30 and the remaining carrier trays are provided with an index between #1 and #29, although the index range may vary depending on the number of carriers 24 provided. The loop conveyor 22 completes at least one cycle and as each index feature 28 is detected the controller 36 is notified by wireless communication and the index of the carrier 24 at the load station 30 is recorded. Once the cycle has finished and all of the divert locations 32 have been indexed, the configuration operation is complete.

In the above-described operation, the configuration sorter tray 38 is described as replacing one of the carriers 24. However, it is also contemplated that the configuration sorter tray 38 may be removably attached to one of the existing carriers 24, or one of the existing carriers may be permanently modified to include a sensor 28 and wireless I/O 44.

During the sorting operation, the configuration sorter tray 38 may be removed from the loop conveyor 22 and replaced with a carrier 24. Articles to be sorted are loaded into indexed carriers 24 at the load station 30. Carriers 24 then proceed along the loop conveyor 22 through each of the divert locations 32. When the carrier 24 containing the article to be sorted arrives at the predetermined divert location 32, the divert device 34 is actuated by the central controller 36 to tilt or otherwise affect carrier 24 to direct the article to be sorted to the output.

During the sorting operation the first step is to determine the divert location for the article to be sorted. In this first step, the preferred divert location for the article to be sorted is communicated to the controller 36. First, the article to be sorted must be identified, such as by manual or automatic scanning of all or part of a one- or two-dimensional barcode, reading an RFID chip, manual input, or other methods known and used in the art. A variety of methods are also contemplated for determining the preferred divert location based on the identity of the article to be sorted. In a preferred method, the article to be sorted includes a unique identifier corresponding to a specific package and destination. This number can be compared to a lookup table to determine the preferred divert location 32. This destination is then communicated to the central controller 36. One example of this lookup table is illustrated in the following sample Table 2:

TABLE 2

| Article number | Divert Location |
|---|---|
| #1026 | #1 |
| #1380 | #3 |
| #1507 | #4 |
| #1931 | #2 |

This lookup table is provided to be an example. Other methods of determining the divert location are contemplated. Further, additional steps may be needed to correlate each article with a divert location. For example, each article to be sorted may be indexed to a destination and each destination may be indexed to a divert location. The relationship between the destination and the divert location, or even the article and destination, may change periodically.

In a second step, the central controller 36 constructs a table between various carrier indices and their preferred divert locations 32, such as illustrated in the following sample Table 3:

TABLE 3

| Carrier Index | Divert Location |
|---|---|
| #1 | #1 |
| #2 | #3 |
| #3 | #4 |
| #4 | #2 |

In a third step, the controller 36 compares the carrier/divert table (Table 3) with the load station/divert index (Table 1) to determine which diverters to activate when each indexed carrier 24 is located at the load station 30, or other reference point. Combining these two tables yields the following sample Table 4 that provides which divert device(s) 34 should be activated when each indexed carrier 24 is at the load station 30:

TABLE 4

| Load Station Index | Divert Location |
|---|---|
| 11 | 1 |
| 19 | 2 |
| 20 | 3 |
| 28 | 4 |

As will be appreciated, as more carriers 24 are filled and with more divert locations 32, multiple divert devices 34 may need to be activated when a single carrier is located at the load station 30.

Finally, during the sorting operation, as each indexed carrier arrives at the reference point (e.g. load station 30), the controller 36 will search the load station/divert table to determine which divert locations 32 should be activated and activate the assigned divert devices 34.

The above described method utilizing lookup tables and indexed discrete carriers 24 is an example version of the sorting operation. As previously described, various types of indices, carriers, and methods of determining the logical position of the divert locations 30 are contemplated, either including or omitting the above-described lookup tables. Further, various methods for diverting items are contemplated. The sorting operation may be adapted to admit variations in the configuration operation.

While the configuration and sorting operations are described as separate, it is contemplated that the two operations may be performed concurrently. According to one embodiment, sensor 28 may be permanently affixed to the loop conveyor 22 for continuously monitoring the logical positions of the divert devices 34 and continuously updating the central controller 36 with these logical positions. This allows the system to adapt to small or large changes in the arrangement of the divert locations, either intentional or accidental; alert operators to changes in the configuration; and provide a low-cost continuous diagnostic and maintenance system.

While certain embodiments have been described, it must be understood that various changes may be made and equivalents may be substituted without departing from the spirit or scope of the present disclosure. In addition, many modifications may be made to adapt a particular situation or material to the teachings of the disclosure without departing from its spirit or scope.

What is claimed is:

1. A method of configuring a sorting system having a plurality of carriers comprising:
providing a sensor on at least one of said carriers;
passing said sensor through each of a plurality of divert locations;
detecting an index feature of at least one divert location;
determining a logical position of said divert location; and
indexing said divert location to said logical position.

2. The method of claim 1 further comprising the step of providing each of said carriers with a carrier index number.

3. The method of claim 2 wherein said logical position of said divert location corresponds with one of said carrier index numbers.

4. The method of claim 1 further comprising the step of providing each of said carriers with more than one index number.

5. The method of claim 1 wherein said sensor comprises an optical sensor.

6. The method of claim 1 wherein said index feature comprises a divert device at said divert location.

7. The method of claim 6 wherein said carrier comprises a tilt tray.

8. An apparatus for configuring a sorting system, the apparatus comprising a carrier tray having mounted thereon:
a sensor for detecting a divert location of the sorter system;
a wireless transmitter in communication with said sensor; and
a power supply coupled to said sensor and wireless transmitter.

9. The apparatus of claim 8 wherein said wireless transmitter is configured to provide a signal to a controller of said sorting system when said divert location is detected.

10. The apparatus of claim 8 wherein said carrier tray comprises a tilt tray.

11. The apparatus of claim 8 wherein said sensor comprises a laser photoeye.

12. The apparatus of claim 8 wherein said carrier tray includes a beacon for visible system feedback.

13. A system for configuring a sorting system comprising:
a conveyor adapted to transport articles from a load station to a plurality of offload stations;
a plurality of divert locations, each divert location including a diverter configured to transfer an article from the conveyor to the offload station;
a control system configured to activate the diverter at a predetermined time to cause a specific article to be diverted to a specific offload station;
a configuration tray removably attachable to the conveyor, the configuration tray including a sensor for detecting the physical position of each diverter location and a transmitter for communicating the physical position of each diverter location to the control system.

14. The system of claim 13 wherein the conveyor comprises a plurality of carriers.

15. The system of claim 14 wherein the configuration tray is adapted to replace one of the carriers during a configuration operation.

16. The system of claim 14 wherein the configuration operation comprises the steps of passing the configuration tray past each divert location; detecting the presence of each divert location; communicating the detection to the central controller; and recording a logical position of each divert location in the central controller.

17. The system of claim 16 wherein each of the plurality of carriers is assigned an index number.

18. The system of claim 17 wherein the logical position of each divert location corresponds to an index number of one of the plurality of carriers.

19. The system of claim 16 wherein the logical position of each divert location corresponds to a time delay between the load station and the divert location.

20. The system of claim 16 wherein the logical position of each divert location corresponds to a distance between the load station and the divert location.

21. The system of claim 13 wherein said system includes a plurality of load stations.
